(19) United States
(12) Patent Application Publication
(10) Pub. No.: US 2024/0223324 A1
(43) Pub. Date: Jul. 4, 2024

(54) SIMULTANEOUS UPLINK TRANSMISSION IN A MULTIPLE TRANSMIT-RECEIVE POINT CONFIGURATION

(71) Applicant: ZTE Corporation, Shenzhen (CN)

(72) Inventors: Yang ZHANG, Shenzhen (CN); Bo GAO, Shenzhen (CN); Shujuan ZHANG, Shenzhen (CN); Ke YAO, Shenzhen (CN); Meng MEI, Shenzhen (CN); Xiaolong GUO, Shenzhen (CN); Zhaohua LU, Shenzhen (CN)

(21) Appl. No.: 18/534,369

(22) Filed: Dec. 8, 2023

Related U.S. Application Data
(63) Continuation of application No. PCT/CN2022/112223, filed on Aug. 12, 2022.

(51) Int. Cl. H04L 5/00; H04W 72/21

(52) U.S. Cl. CPC H04L 5/0035; H04L 5/0048; H04W 72/21

(57) ABSTRACT

A method of wireless communication includes transmitting, upon determining that a wireless device operating in a multiple transmission reception point wireless configuration with a network device satisfies a condition, one or more uplink control transmissions using codebook based precoding. The one or more uplink control transmissions are performed according to a configuration information received from a network device that indicates one or more sounding reference signal (SRS) resource sets associated with the one or more uplink control transmission.

### CROSS-REFERENCE TO RELATED APPLICATION

This application is a continuation and claims priority to International Application No. PCT/CN2022/112223, filed on Aug. 12, 2022, the disclosure of which is hereby incorporated by reference herein in its entirety.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient bandwidth utilization.

### SUMMARY

Various methods and apparatus for supporting configuration and transmission of uplink control channel in a wireless communication system that supports multi-transmission reception point configurations.

In one example aspect, a method of wireless communication is disclosed. The method includes transmitting, upon determining that a wireless device operating in a multiple transmission reception point wireless configuration with a network device satisfies a condition, one or more uplink control transmissions using codebook-based precoding. the one or more uplink control transmissions are performed according to a configuration information received from a network device that indicates one or more sounding reference signal (SRS) resource sets associated with the one or more uplink control transmission.

In another example aspect, another method of wireless communication is disclosed. The method includes transmitting, upon determining that a wireless device operating in a multiple transmission reception point wireless configuration with a network device satisfies a condition, one or more uplink control transmissions using a non-codebook-based precoding. The one or more uplink control transmissions are performed according to a configuration information received from a network device that indicates of one or more sounding reference signal (SRS) resource sets associated with the one or more uplink control transmission.

In yet another example aspect, another method of wireless communication is disclosed. The method includes transmitting, upon determining that a wireless device operating in a multiple transmission reception point wireless configuration with a network device satisfies a condition, one or more uplink control transmissions according to a schedule from a network device wherein the one or more uplink control transmissions are performed according to a frequency domain resource allocation provided by the network device.

In yet another example aspect, another method of wireless communication is disclosed. The method includes transmitting, by a network device to a wireless device, configuration information that indicates one or more sounding reference signal (SRS) resource sets associated with the one or more uplink control transmission; and receiving, from a wireless device that satisfies a condition and is operating in a multiple transmission reception point wireless configuration, one or more uplink control transmissions using codebook based precoding according to the configuration information.

In yet another example aspect, another method of wireless communication is disclosed. The method includes transmitting, by a network node, configuration information to a wireless device, wherein the configuration information indicates one or more sounding reference signal (SRS) resource sets associated with the one or more uplink control transmission that the wireless device is to use upon satisfying a condition while operating in a multiple transmission reception point wireless configuration with the network device; and receiving, from the wireless device according to the condition, the one or more uplink control transmissions using a non-codebook-based precoding.

In yet another example aspect, another method of wireless communication is disclosed. The method includes transmitting, by a network device to a wireless device, a schedule for use by a wireless device operating in a multiple transmission reception point wireless to perform one or more uplink control transmissions to a network device upon satisfying a condition; and receiving, by the network device, one or more uplink control transmissions according to the schedule.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 is a block diagram of an example of a wireless communication apparatus.

FIG. 2 shows an example wireless communications network.

FIGS. 3A-3F are flowcharts of example wireless communication methods based on some implementations of the disclosed technology.

### DETAILED DESCRIPTION

Section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

In the current 5G NR system, several transmission schemes of multiple transmission reception point (MTRP) operation have been supported for uplink (UL) transmissions on top of single transmission reception point (STRP) operation to improve the reliability and throughput of UL channels or signals. However, due to the restriction of the current UE capability, multiple uplink transmissions can only be performed as non-overlapped in time domain even though the UE is equipped with more than one panel, which would be a bottleneck for the reliability and throughput of whole system once multi-TRP based uplink transmission can be supported.

With the evolution of the mobile communication technology, the UE equipped with multiple panels could be supported to simultaneously transmit more than one uplink transmission. On the other hand, due to different channel conditions of the link between multiple panels of the UE and multiple TRPs when MTRP operation, some transmission parameters (e.g., transmission precoder and spatial relation indication) should be dedicated between the panel and TRP for better performance.

Based on the above, some specific issues need to be addressed for the case of simultaneous uplink transmission across multiple UE panels and towards different TRPs: (i) how to determine SRS resource set configured for CB based simultaneous PUSCH repetitions in MTRP operation? (ii) how to determine SRS resource set configured for CB based simultaneous PUSCH non-repetitions in MTRP operation? (iii) how to determine SRS resource set configured for NCB based simultaneous PUSCH repetitions in MTRP operation? (iv) how to determine SRS resource set configured for NCB based simultaneous PUSCH non-repetitions in MTRP operation? (v) how to determine frequency domain resource allocations for simultaneous PUSCH transmissions in MTRP operation?

The following abbreviations are used in the present document.

| Acronym | Full Form |
|---|---|
| NR | New radio |
| UE | User equipment |
| NW | Network |
| TRP | Transmit receive point |
| PUSCH | Physical uplink shared channel |
| SRS | Sounding reference signal |
| DM-RS | Demodulation reference signal |
| RRC | Radio resource control |
| MAC CE | Medium access control control element |
| DCI | Downlink control information |
| TPMI | Transmission precoding matrix indication |
| SRI | SRS resource indicator |
| MSB | The most significant bit |
| LSB | The least significant bit |
| TCI | Transmission configuration indication |
| QCL | Quasi Co-location |

In Rel-15 and Rel-16 NR, due to PUSCH transmission towards a single TRP only, the UE uses a same indicated information for the repeated transmission across multiple slots, which means that each of these transmissions uses the same spatial relation and transmission precoder. Note that both codebook based and non-codebook based PUSCH transmission are supported since Rel-15.

For codebook based PUSCH transmission, PUSCH can be scheduled by DCI (i.e., DCI format 0_0, DCI format 0_1, DCI format 0_2) or RRC signaling (i.e., the higher layer parameter ConfiguredGrantConfig), and the UE determines its PUSCH transmission precoder based on SRI, TPMI and the transmission rank. Where the SRI, TPMI and the transmission rank are given by some fields in DCI (i.e., SRS resource indicator field, Second SRS resource indicator field, Second Precoding information and number of layers field, Precoding information and number of layers field) or given by some higher layer parameters in RRC signaling (i.e., srs-ResourceIndicator, srs-ResourceIndicator 2, precodingAndNumberOfLayers, precodingAndNumberOfLayers2).

For non-codebook based PUSCH transmission, in contrast to codebook based scheme, the UE determines its precoder and transmission rank based on the SRI when multiple SRS resources are configured in a SRS resource set, where the SRI is given by the SRS resource indicator in DCI. Specifically, the UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one SRS resource set can be configured with higher layer parameter usage in SRS-ResourceSet set to ‘nonCodebook’. The maximum number of SRS resources in one SRS resource set that can be configured for non-codebook based PUSCH transmission is 4. The indicated SRI in slot n is associated with the most recent transmission of SRS resource(s) identified by the SRI, where the SRS transmission is prior to the PDCCH carrying the SRI. After that, the UE can calculate the precoder used for the transmission of SRS based on measurement of an associated NZP CSI-RS resource. The UE selection of a precoder (and the number of layers) for each scheduled PUSCH may be modified by the network (in case multiple SRS resources are configured). The UE shall transmit PUSCH using the same antenna ports as the SRS port(s) in the SRS resource(s) indicated by SRI given by DCI.

### Frequency Domain Resource Allocation Examples

Resource Allocation Type (in frequency domain) indicates a method for resource allocation in frequency domain. Resource Allocation Type specifies the way in which the scheduler allocate resource blocks for each transmission.

According to the current approach in 3GPP specifications, the Resource Allocation Type is determined implicitly by DCI format or by RRC signaling as described below.

The UE may assume that when the scheduling grant is received with DCI format 1_0 downlink resource allocation type 1 is used.

If the scheduling DCI is configured to indicated the uplink resource allocation type as part of the Frequency domain resource assignment field, the UE shall use uplink resource allocation type 0 or type 1 as defined by this field. Otherwise the UE shall use the uplink frequency resource allocation type as defined by the higher layer parameter resource Allocation for PUSCH.

### Allocation Type 0

In this type, a number of consecutive RBs into RBG (Resource Block Group) are bundled and allocate PUSCH only in the multiples of RBG. The number of RBs within a RBG varies depending on Bandwidth Part Size and Configuration as shown in the following table. The configuration type is determined by the higher layer parameter rbg-Size in PDSCH-Config. The bitmap in DCI indicates the RBG number that carries PDSCH or PUSCH data. Since this is a bitmap, it is not required for the RBGs to be consecutive.

<TS38.214 - Table 6.1.2.2.1-1: Nominal RBG size P>

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

### Allocation Type 1

In this type, the resource is allocated to one or more consecutive RBs. The resource allocation area is defined by two parameters RB_Start and Number of Consecutive RBs within a specific BWP. When the resource allocation is specified in DCI, RB_Start and Number of Consecutive RBs within the BWP is combined into a specific single value called RIV (Resource Indicator Value).

### Dynamic Switch

Whether to use Type 0 or Type 1 is determined by the Frequency domain resource assignment field in DCI at the time of each transmission.
If the scheduling DCI is configured to indicate the uplink resource allocation type as part of the Frequency domain resource assignment field by setting a higher layer parameter resource Allocation in pusch-Config to ‘dynamicSwitch’, for DCI format 0_1 or setting a higher layer parameter resourceAllocationDCI-0-2 in pusch-Config to ‘dynamicSwitch’ for DCI format 0_2, the UE shall use uplink resource allocation type 0 or type 1 as defined by this DCI field. Otherwise the UE shall use the uplink frequency resource allocation type as defined by the higher layer parameter resourceAllocation for DCI format 0_1 or the higher layer parameter resource AllocationDCI-0-2 for DCI format 0_2. The UE shall assume that when the scheduling PDCCH is received with DCI format 0_1 and useInterfacePUCCH-PUSCH in BWP-UplinkDedicated is configured, uplink type 2 resource allocation is used.
If resource Allocation is configured as ‘dynamicSwitch’, the MSB bit is used to indicate resource allocation type 0 or resource allocation type 1, where the bit value of 0 indicates resource allocation type 0 and the bit value of 1 indicates resource allocation type 1.

### Other Aspects

In general, 5G NR includes a number of MIMO features that facilitate utilization of a large number of antenna elements at base station for both sub-6 GHZ (Frequency Range 1, FR1) and over-6 GHz (Frequency Range 2, FR2) frequency bands, plus one of the MIMO features is that it supports for multi-TRP operation. The key point of this functionality is to collaborate with multiple TRPs to transmit or receive data to the UE to improve transmission performance. As NR is in the process of commercialization, various aspects that require further enhancements can be identified from real deployment scenarios. According to the current evolution for 5G NR in 3GPP, simultaneous uplink transmissions can be supported and performed by multi-panel UE in MTRP operation, which is beneficial to improve the throughput of uplink transmission.

In some embodiments, “simultaneous uplink transmission scheme” is equivalent to multiple uplink transmissions can be fully or partially overlapped in time domain, where the simultaneous uplink transmissions can be associated with different panel/TRP ID, and these simultaneous uplink transmissions can be scheduled by a single DCI or multiple DCI. Beside, whether the UE supports the “simultaneous uplink transmission scheme” can be reported as the UE optional capability.

In some embodiments, “TRP” is equivalent to at least one of: SRS resource set, spatial relation, power control parameter set, TCI state, CORESET, CORESETPoolIndex, physical cell index (PCI), sub-array, CDM group of DMRS ports, the group of CSI-RS resources or CMR set.

In some embodiments, “UE panel” is equivalent to at least one of: UE capability value set, antenna group, antenna port group, beam group, sub-array, SRS resource set or panel mode.

In some embodiments, the definition of “beam state” is equivalent to at least one of: quasi-co-location (QCL) state, transmission configuration indicator (TCI) state, spatial relation (also called as spatial relation information), reference signal (RS), spatial filter or precoding. Furthermore, in this patent, “beam state” is also called as “beam”. Specifically,
The definition of “Tx beam” is equivalent to at least one of: QCL state, TCI state, spatial relation state, DL reference signal, UL reference signal, Tx spatial filter or Tx precoding;
The definition of “Rx beam” is equivalent to at least one of: QCL state, TCI state, spatial relation state, spatial filter, Rx spatial filter or Rx precoding;
The definition of “beam ID” is equivalent to at least one of: QCL state index, TCI state index, spatial relation state index, reference signal index, spatial filter index or precoding index.

Specifically, the spatial filter can be either UE-side or gNB-side one, and the spatial filter is also called as spatial-domain filter.

In some embodiments, “spatial relation” is comprised of one or more reference RSs, which is used to represent the same or quasi-co “spatial relation” between targeted “RS or channel” and the one or more reference RSs.

In some embodiments, “spatial relation” also means at least one of: the beam, spatial parameter or spatial domain filter.

In some embodiments, a “QCL state” is comprised of one or more reference RSs and their corresponding QCL type parameters, where QCL type parameters include at least one of the following aspect or combination: [1] Doppler spread, [2] Doppler shift, [3] delay spread, [4] average delay, [5] average gain, and [6] Spatial parameter (which is also called as spatial Rx parameter). In this patent, “TCI state” is equivalent to “QCL state”. In this patent, there are the following definitions for ‘QCL-TypeA’, ‘QCL-TypeB’, ‘QCL-TypeC’, and ‘QCL-TypeD’.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

In some embodiments, a RS comprises channel state information reference signal (CSI-RS), synchronization signal block (SSB) (which is also called as SS/PBCH), demodulation reference signal (DMRS), sounding reference signal (SRS), and physical random access channel (PRACH). Furthermore, the RS at least comprises DL reference signal and UL reference signalling.
A DL RS at least comprises CSI-RS, SSB, DMRS (e.g., DL DMRS);
A UL RS at least comprises SRS, DMRS (e.g., UL DMRS), and PRACH.

In some embodiments, “UL signal” can be PUCCH, PUSCH, or SRS.

In some embodiments, “DL signal” can be PDCCH, PDSCH, or CSI-RS.

### Embodiment Examples 1

These embodiment examples may be used to, in one aspect, address the issue (i) discussed above. These embodiments incorporate, e.g., SRS resource set related configuration for CB based simultaneous PUSCH repetition in MTRP operation.

If at least one of the following conditions is satisfied,
1) The UE is scheduled to transmit more than one PUSCH repetition simultaneously, wherein the time domain of these PUSCH repetitions are fully or partially overlapped.
   a. Wherein, the PUSCH repetition can be at least one of: inter-slot based PUSCH repetition or intra-slot based PUSCH repetition.
2) The more than one PUSCH repetition are associated with one or more SRS resource sets, which are configured in srs-ResourceSetToAddModList or srs-ResourceSetToAddModListDCI-0-2 with higher layer parameter usage in SRS-ResourceSet set to ‘codebook’.
3) For codebook based transmission scheme, the PUSCH can be scheduled by DCI format 0_1, DCI format 0_2 or RRC signaling.
4) For these PUSCH repetitions transmitted simultaneously, each of PUSCH repetitions is associated with one SRS resource set.

The UE may gets and applies the configuration of one or more SRS resource sets which associated with these PUSCH repetitions.
1) Further, the SRS resource set configuration is determined by RRC signaling.
2) Further, the SRS resource set configuration comprise at least one of the following parameters:
   a. Parameter-1, the number of SRS resources in the SRS resource set.
      a) Wherein, the number of SRS resources configured in different SRS resource sets can be the same or different.
         i. For an example, if the number of SRS resource sets is 2, the number of SRS resources configured in the first SRS resource set is 1, and the number of SRS resources configured in the second SRS resource set is 2.
         ii. For another example, if the number of SRS resource sets is 2, the number of SRS resources configured in the first SRS resource set is 2, and the number of SRS resources configured in the second SRS resource set is 2.
      b) Wherein, the number of SRS resources configured in different SRS resource sets is determined by the higher layer parameter srs-ResourceIdList in SRS-Config.
      c) Wherein, the maximum number of SRS resources configured in an SRS resource set depends on the UE capability reporting.
         i. Optionally, the UE reports the maximum number of SRS resources supported in each SRS resource set respectively.
         ii. Optionally, the UE reports a total number of SRS resources supported in all SRS resource sets jointly.
         i) Further, if the number of SRS resources configured in each SRS resource set is the same, the number of SRS resources of each SRS resource set is equivalent to the total number of supported SRS resources divided by the number of configured SRS resource sets.
         a. For an example, the UE reports the total number of SRS resources is 4 and the number of configured SRS resource sets is 2, then the maximum number of SRS resources configured in each SRS resource set is equivalent to 2.
      d) Wherein, except when higher layer parameter ul-FullPowerTransmission is set to ‘fullpowerMode2’, the maximum number of SRS resources configured in an SRS resource set is 2. Others, subject to UE capability, a maximum of 2 or 4 SRS resources can be configured in an SRS resource set.
      e) Wherein, if the PUSCH repetition is scheduled by DCI format 0_2, its corresponding SRS resource set is composed of the first N_{SRS,0_2} SRS resources together with other configurations in the SRS resource set which used for the PUSCH repetition scheduled by DCI format 0_1 and configured with the higher layer parameter usage of value ‘codeBook’.
         i. Further, the value of N_{SRS,0_2} configured in different SRS resource sets can be the same or different.
         i) Wherein, the SRS resource set is configured by higher layer parameter rs-ResourceSetToAddModListDCI-0-2 or indicated by the SRS resource set indicator field in DCI.
         ii) Wherein, the index of the SRS resource set associated with the PUSCH repetition scheduled by DCI format 0_2 is the same as the index of the SRS resource set associated with the PUSCH repetition scheduled by DCI format 0_1.
   b. Parameter-2, the number of antenna ports configured in SRS resource.
      a) Wherein, the number of antenna ports of each SRS resource configured within an SRS resource set should be the same.
      b) Wherein, the number of antenna ports of SRS resources configured in different SRS resource sets can be the same or different.
      c) Wherein, the number of antenna ports of SRS resources configured in different SRS resource sets is determined by the higher layer parameter nrofSRS-Ports in SRS-Config.
      d) Further, the maximum transmission layers of these PUSCH repetitions should be equal to or less than the smallest of the maximum antenna ports of the indicated SRS resources in all SRS resource sets.

### Embodiment Examples 2

These embodiment examples may be used to, in one aspect, address the issue (ii) discussed above. These embodiments incorporate, e.g., SRS resource set related configuration for CB based simultaneous PUSCH transmission in MTRP operation.

If at least one of the following conditions is satisfied,
1) The UE is scheduled to transmit more than one PUSCH transmission simultaneously, wherein the time domain of these PUSCH transmissions are fully or partially overlapped.
   a. Wherein, the PUSCH transmission can be at least one of: inter-slot based PUSCH transmission or intra-slot based PUSCH transmission.
   b. Wherein, the content of each PUSCH transmission is different.
2) The more than one PUSCH transmission are associated with one or more SRS resource sets, which are configured in srs-Resource SetToAddModList or srs-Resource SetToAddModListDCI-0-2 with higher layer parameter usage in SRS-ResourceSet set to ‘codebook’.
3) For codebook based transmission scheme, the PUSCH can be scheduled by DCI format 0_1, DCI format 0_2 or RRC signaling.
4) For these PUSCH transmissions transmitted simultaneously, each of PUSCH transmissions is associated with one SRS resource set.

The UE may gets and applies the configuration of one or more SRS resource sets which associated with these PUSCH transmissions.
1) Further, the SRS resource set configuration is determined by RRC signaling.
2) Further, the SRS resource set configuration comprise at least one of the following parameters:
   a. Parameter-1, the number of SRS resources in the SRS resource set.
      a) Wherein, the number of SRS resources configured in different SRS resource sets can be the same or different.
         i. For an example, if the number of SRS resource sets is 2, the number of SRS resources configured in the first SRS resource set is 1, and the number of SRS resources configured in the second SRS resource set is 2.
         ii. For another example, if the number of SRS resource sets is 2, the number of SRS resources configured in the first SRS resource set is 2, and the number of SRS resources configured in the second SRS resource set is 2.
      b) Wherein, the number of SRS resources configured in different SRS resource sets is determined by the higher layer parameter srs-ResourceIdList in SRS-Config.
      c) Wherein, the maximum number of SRS resources configured in an SRS resource set depends on the UE capability reporting.
         i. Optionally, the UE reports the maximum number of SRS resources supported in each SRS resource set respectively.
         ii. Optionally, the UE reports a total number of SRS resources supported in all SRS resource sets jointly.
         i) Further, if the number of SRS resources configured in each SRS resource set is the same, the number of SRS resources of each SRS resource set is equivalent to the total number of supported SRS resources divided by the number of configured SRS resource sets.
         a. For an example, the UE reports the total number of SRS resources is 4 and the number of configured SRS resource sets is 2, then the maximum number of SRS resources configured in each SRS resource set is equivalent to 2.
      d) Wherein, except when higher layer parameter ul-FullPowerTransmission is set to ‘fullpowerMode2’, the maximum number of SRS resources configured in an SRS resource set is 2. Others, subject to UE capability, a maximum of 2 or 4 SRS resources can be configured in an SRS resource set.
      e) Wherein, if the PUSCH transmission is scheduled by DCI format 0_2, its corresponding SRS resource set is composed of the first N_{SRS,0_2} SRS resources together with other configurations in the SRS resource set which used for the PUSCH transmission scheduled by DCI format 0_1 and configured with the higher layer parameter usage of value ‘codeBook’.
         i. Further, the value of N_{SRS,0_2} configured in different SRS resource sets can be the same or different.
         i) Wherein, the SRS resource set is configured by higher layer parameter rs-ResourceSetToAddModListDCI-0-2 or indicated by the SRS resource set indicator field in DCI.
         ii) Wherein, the index of the SRS resource set associated with the PUSCH transmission scheduled by DCI format 0_2 is the same as the index of the SRS resource set associated with the PUSCH transmission scheduled by DCI format 0_1.
   b. Parameter-2, the number of antenna ports configured in SRS resource.
      a) Wherein, the number of antenna ports of each SRS resource configured within an SRS resource set should be the same.
      b) Wherein, the number of antenna ports of SRS resources configured in different SRS resource sets can be the same or different.
      c) Wherein, the number of antenna ports of SRS resources configured in different SRS resource sets is determined by the higher layer parameter nrofSRS-Ports in SRS-Config.
      d) Further, the maximum transmission layers of these PUSCH transmissions should be equal to or less than the maximum antenna ports of the indicated SRS resources in its related SRS resource set.

### Embodiment Examples 3

These embodiment examples may be used to, in one aspect, address the issue (iii) discussed above. These embodiments incorporate, e.g., SRS resource set related configuration for NCB based simultaneous PUSCH repetition in MTRP operation.

If at least one of the following conditions is satisfied,
1) The UE is scheduled to transmit more than one PUSCH repetition simultaneously, wherein the time domain of these PUSCH repetitions are fully or partially overlapped.
   a. Wherein, the PUSCH repetition can be at least one of: inter-slot based PUSCH repetition or intra-slot based PUSCH repetition.
2) The more than one PUSCH repetition are associated with one or more SRS resource sets, which are configured in srs-ResourceSetToAddModList or srs-ResourceSetToAddModListDCI-0-2 with higher layer parameter usage in SRS-ResourceSet set to ‘nonCodebook’.
3) For non-codebook based transmission scheme, the PUSCH can be scheduled by DCI format 0_1, DCI format 0_2 or RRC signaling.
4) For these PUSCH repetitions transmitted simultaneously, each of PUSCH repetitions is associated with one SRS resource set.

The UE may gets and applies the configuration of one or more SRS resource sets which associated with these PUSCH repetitions.
1) Further, the SRS resource set configuration is determined by RRC signaling.
2) Further, the SRS resource set configuration comprise at least one of the following parameters:
   a. Parameter-1, the number of SRS resources in the SRS resource set.
      a) Wherein, the number of SRS resources configured in different SRS resource sets can be the same or different.
         i. For an example, if the number of SRS resource sets is 2, the number of SRS resources configured in the first SRS resource set is 1, and the number of SRS resources configured in the second SRS resource set is 2.
         ii. For another example, if the number of SRS resource sets is 2, the number of SRS resources configured in the first SRS resource set is 2, and the number of SRS resources configured in the second SRS resource set is 2.
      b) Wherein, the number of SRS resources configured in different SRS resource sets is determined by the higher layer parameter srs-ResourceIdList in SRS-Config.
      c) Wherein, the maximum number of SRS resources configured in an SRS resource set depends on the UE capability reporting.
         i. Optionally, the UE reports the maximum number of SRS resources supported in each SRS resource set respectively.
         ii. Optionally, the UE reports a total number of SRS resources supported in all SRS resource sets jointly.
         i) Further, if the number of SRS resources configured in each SRS resource set is the same, the number of SRS resources of each SRS resource set is equivalent to the total number of supported SRS resources divided by the number of configured SRS resource sets.
         a. For an example, the UE reports the total number of SRS resources is 4 and the number of configured SRS resource sets is 2, then the maximum number of SRS resources configured in each SRS resource set is equivalent to 2.
      d) Wherein, except when higher layer parameter ul-FullPowerTransmission is set to ‘fullpowerMode2’, the maximum number of SRS resources configured in an SRS resource set is 2. Others, subject to UE capability, a maximum of 2 or 4 SRS resources can be configured in an SRS resource set.
      e) Wherein, if the PUSCH repetition is scheduled by DCI format 0_2, its corresponding SRS resource set is composed of the first N_{SRS,0_2} SRS resources together with other configurations in the SRS resource set which used for the PUSCH repetition scheduled by DCI format 0_1 and configured with the higher layer parameter usage of value ‘codeBook’.
         i. Further, the value of N_{SRS,0_2} configured in different SRS resource sets can be the same or different.
         i) Wherein, the SRS resource set is configured by higher layer parameter rs-ResourceSetToAddModListDCI-0-2 or indicated by the SRS resource set indicator field in DCI.
         ii) Wherein, the index of the SRS resource set associated with the PUSCH repetition scheduled by DCI format 0_2 is the same as the index of the SRS resource set associated with the PUSCH repetition scheduled by DCI format 0_1.
      f) Further, the maximum transmission layers of these PUSCH repetitions should be equal to or less than the smallest of the maximum number of the configured SRS resources in all SRS resource sets.
   b. Parameter-2, the associated NZP CSI-RS resource.
      a) Wherein, the associated NZP CSI-RS of each SRS resource set can be the same or different.
      b) Wherein, the associated NZP CSI-RS is configured by the higher layer parameter associatedCSI-RS in SRS-ResourceSet.

### Embodiment Examples 4

These embodiment examples may be used to, in one aspect, address the issue (iv) discussed above. These embodiments incorporate, e.g., SRS resource set related configuration for NCB based simultaneous PUSCH transmission in MTRP operation.

If at least one of the following conditions is satisfied,
1) The UE is scheduled to transmit more than one PUSCH transmission simultaneously, wherein the time domain of these PUSCH transmissions are fully or partially overlapped.
   a. Wherein, the PUSCH transmission can be at least one of: inter-slot based PUSCH transmission or intra-slot based PUSCH transmission.
   b. Wherein, the content of each PUSCH transmission is different.
2) The more than one PUSCH transmission are associated with one or more SRS resource sets, which are configured in srs-Resource SetToAddModList or srs-Resource SetToAddModListDCI-0-2 with higher layer parameter usage in SRS-ResourceSet set to ‘nonCodebook’.
3) For non-codebook based transmission scheme, the PUSCH can be scheduled by DCI format 0_1, DCI format 0_2 or RRC signaling.
4) For these PUSCH transmissions transmitted simultaneously, each of PUSCH transmissions is associated with one SRS resource set.

The UE may gets and applies the configuration of one or more SRS resource sets which associated with these PUSCH transmissions.
1) Further, the SRS resource set configuration is determined by RRC signaling.
2) Further, the SRS resource set configuration comprise at least one of the following parameters:
   a. Parameter-1, the number of SRS resources in the SRS resource set.
      a) Wherein, the number of SRS resources configured in different SRS resource sets can be the same or different.
         i. For an example, if the number of SRS resource sets is 2, the number of SRS resources configured in the first SRS resource set is 1, and the number of SRS resources configured in the second SRS resource set is 2.
         ii. For another example, if the number of SRS resource sets is 2, the number of SRS resources configured in the first SRS resource set is 2, and the number of SRS resources configured in the second SRS resource set is 2.
      b) Wherein, the number of SRS resources configured in different SRS resource sets is determined by the higher layer parameter srs-ResourceIdList in SRS-Config.
      c) Wherein, the maximum number of SRS resources configured in an SRS resource set depends on the UE capability reporting.
         i. Optionally, the UE reports the maximum number of SRS resources supported in each SRS resource set respectively.
         ii. Optionally, the UE reports a total number of SRS resources supported in all SRS resource sets jointly.
         i) Further, if the number of SRS resources configured in each SRS resource set is the same, the number of SRS resources of each SRS resource set is equivalent to the total number of supported SRS resources divided by the number of configured SRS resource sets.
         a. For an example, the UE reports the total number of SRS resources is 4 and the number of configured SRS resource sets is 2, then the maximum number of SRS resources configured in each SRS resource set is equivalent to 2.
      d) Wherein, except when higher layer parameter ul-FullPowerTransmission is set to ‘fullpowerMode2’, the maximum number of SRS resources configured in an SRS resource set is 2. Others, subject to UE capability, a maximum of 2 or 4 SRS resources can be configured in an SRS resource set.
      e) Wherein, if the PUSCH transmission is scheduled by DCI format 0_2, its corresponding SRS resource set is composed of the first N_{SRS,0_2} SRS resources together with other configurations in the SRS resource set which used for the PUSCH transmission scheduled by DCI format 0_1 and configured with the higher layer parameter usage of value ‘codeBook’.
         i. Further, the value of N_{SRS,0_2} configured in different SRS resource sets can be the same or different.
         i) Wherein, the SRS resource set is configured by higher layer parameter rs-ResourceSetToAddModListDCI-0-2 or indicated by the SRS resource set indicator field in DCI.
         ii) Wherein, the index of the SRS resource set associated with the PUSCH transmission scheduled by DCI format 0_2 is the same as the index of the SRS resource set associated with the PUSCH repetition scheduled by DCI format 0_1.
      f) Further, the maximum transmission layers of these PUSCH transmissions should be equal to or less than the total of the configured SRS resources in its SRS resource set.
   b. Parameter-2, the associated NZP CSI-RS resource.
      a) Wherein, the associated NZP CSI-RS of each SRS resource set can be the same or different.
      b) Wherein, the associated NZP CSI-RS is configured by the higher layer parameter associatedCSI-RS in SRS-ResourceSet.

### Embodiment Examples 5

These embodiment examples may be used to, in one aspect, address the issue (v) discussed above. These embodiments incorporate, e.g., FDRA (Frequency Domain Resource Assignment) indication for FDM (Frequency-domain Divided Multiplexing) based simultaneous PUSCH transmission scheduled by single DCI in MTRP operation.

If at least one of the following conditions is satisfied,
1) The UE is scheduled to transmit a plurality of PUSCH transmissions simultaneously, wherein the time domain of these PUSCH transmissions are fully or partially overlapped.
   a. Wherein, the PUSCH transmission can be at least one of: inter-slot based PUSCH transmission or intra-slot based PUSCH transmission.
   b. Wherein, the PUSCH transmission is equivalent to at least one of: a PUSCH repetition, a PUSCH non-repetition, a PUSCH transmission occasion.
2) The plurality of PUSCH transmissions are transmitted in non-consecutive resource allocations in frequency domain.
3) The plurality of PUSCH transmissions are indicated with the same or different RV.
4) The more than one PUSCH transmission are associated with one or more SRS resource sets, which are configured in srs-Resource SetToAddModList or srs-Resource SetToAddModListDCI-0-2 with higher layer parameter usage in SRS-ResourceSet set to ‘codebook’ or ‘nonCodebook’.
   a. Further, if more than one SRS resource sets are configured, each of PUSCH transmissions is associated with one SRS resource set.
   b. For codebook or non-codebook based transmission scheme, the PUSCH can be scheduled by DCI format 0_1, DCI format 0_2 or RRC signaling only.
5) These PUSCH transmissions are indicated with different beams or spatial relations.
6) These PUSCH transmissions can be scheduled to transmit in frequency range 1 or frequency range 2.

The UE may gets and applies the frequency domain resource allocations of these PUSCH transmissions.
1) Wherein, the frequency domain resource allocations of these PUSCH transmissions are assigned by at least one of the following principles.
   a. When these PUSCH transmissions are transmitted by CP-OFDM waveforms and in the case of uplink resource allocation scheme type 0,
      a) if these PUSCH transmissions are transmitted in frequency range 1,
         i. only if the frequency domain resources are located in ‘almost contiguous allocation’, the frequency domain resource allocations between different PUSCH transmissions within a component carrier can be non-contiguous or contiguous. For example, 3GPP TS 38.101-1 section 6.2.2 described one embodiment of almost contiguous allocations.
         i) Further, the frequency domain resource allocation of each PUSCH transmission can be non-contiguous or contiguous.
         ii. otherwise, the frequency domain resource allocations between different PUSCH transmissions are contiguous.
         i) Further, the frequency domain resource allocation of each PUSCH transmission is contiguous.
      b) if these PUSCH transmissions are transmitted in frequency range 2,
         i. the frequency domain resource allocations between different PUSCH transmissions are contiguous.
         i) Further, the frequency domain resource allocation of each PUSCH transmission is contiguous.
   b. When these PUSCH transmissions are transmitted by CP-OFDM waveforms, and in the case of uplink resource allocation scheme type 1 or 2, and no matter these PUSCH transmissions are transmitted in frequency range 1 or frequency range 2,
      a) the frequency domain resource allocations between different PUSCH transmissions are contiguous.
         i. Further, the frequency domain resource allocation of each PUSCH transmissions is contiguous.
   c. When these PUSCH transmissions are transmitted by DFT-s-OFDM waveforms, and no matter these PUSCH transmissions are transmitted in frequency range 1 or frequency range 2, the uplink resource allocation scheme type 0 is not supported.
   d. When these PUSCH transmissions are transmitted by DFT-s-OFDM waveforms and in the case of uplink resource allocation scheme type 1 or type 2, if these PUSCH transmissions are transmitted in frequency range 1 or in frequency range 2,
      a) the frequency domain resource allocations between different PUSCH transmissions are contiguous.
         i. Further, the frequency domain resource allocation of each PUSCH transmission is contiguous.
2) Wherein, the frequency domain resource allocation of each PUSCH transmission is indicated by at least one of FDRA indication fields in DCI format 0_1 or DCI format 0_2.
   a. Further, the uplink resource allocation scheme indicated by the FDRA indication field is determined by the higher layer parameter resourceAllocation in the case of DCI format 0_1 and the higher layer parameter resourceAllocationDCI-0-2 in the case of DCI format 0_2.
      a) Further, the value of the higher layer parameter resourceAllocation or resource AllocationDCI-0-2 can be set as ‘resourceAllocation Type0’, ‘resourceAllocation Type1’ or ‘dynamicSwitch’.
   b. Optionally, more than one FDRA indication field are used to indicate the frequency domain resource allocations of all these PUSCH transmissions.
      a) Optionally, each of the plurality of indication fields is used to indicate the frequency domain resource allocation of each PUSCH transmission.
         i. For example, if the number of these PUSCH transmissions is two, and then two FDRA indication fields are used to indicate the frequency domain resource allocations of these two PUSCH transmissions, respectively.
   c. Optionally, only one FDRA indication field is used to indicate the frequency domain resource allocations of all these PUSCH transmissions.
      a) Further, different parts of the indicated frequency domain resource allocations are used for different PUSCH transmissions, respectively. Where the number of the divided parts is equivalent to the number of these PUSCH transmissions.
         i. Optionally, the indicated frequency domain resource allocations are equally split to multiple parts for each PUSCH transmissions.
         i) For example, if the number of these PUSCH transmission is 2, the first half of the indicated frequency domain resource allocations is used for the first PUSCH transmission, and the second half of the indicated frequency domain resource allocations is used for the second PUSCH transmission.
         ii. Optionally, even RBs and odd RBs within the allocated frequency domain resources are used for different PUSCH transmissions.
         i) For example, if the number of these PUSCH transmission is 2, the even RBs within the allocated frequency domain resources are used for the first PUSCH transmission, and the odd RBs within the allocated frequency domain resources are used for the first PUSCH transmission.
         iii. Optionally, even RBGs (resource block group, which refers to a group of contiguous RBs) and odd RBGs within the allocated frequency domain resources are used for different PUSCH transmissions.
         i) For example, if the number of these PUSCH transmission is 2, the even RBGs within the allocated frequency domain resources are used for the first PUSCH transmission, and the odd RBGs within the allocated frequency domain resources are used for the first PUSCH transmission.
         iv. Optionally, the indicated frequency domain resource allocations are split by a factor to determine the part of the indicated frequency domain resource allocations.
         i) Optionally, the factor associated to each PUSCH transmission can be the same or different.
         ii) Optionally, the factor depends on the MCS used for the PUSCH transmission.
         iii) Optionally, the factor depends on the transmission layer number of the PUSCH transmission.
         a. Optionally, the transmission layer number is determined by the higher layer parameter in RRC signaling.
         b. Optionally, the transmission layer number is determined by the indication in DCI.
         iv) Optionally, the factor depends on the UE capability reporting which associated with the PUSCH transmission.
         v) Optionally, the factor depends on the antenna port number of the PUSCH transmission.
         a. Optionally, the antenna port number is determined by the higher layer parameter in RRC signaling.
         b. Optionally, the antenna port number is determined by the indication in DCI.
         vi) Optionally, the factor is configured by the higher layer parameter in RRC signaling of each PUSCH transmission.
   d. Optionally, only one FDRA indication field is used to indicate the frequency domain resource allocation of one first PUSCH transmission, and then an offset of frequency domain resource allocations between the first PUSCH transmission and other PUSCH transmission is determined for the frequency domain resource allocation of the other PUSCH transmission.
      a) Optionally, the offset is indicated by a field in the scheduling DCI.
      b) Optionally, the offset is configured by a higher layer parameter in RRC signaling.
      c) Optionally, the offset is the gap between the first RB of the first PUSCH transmission and the first RB of the other PUSCH transmission in frequency domain.
      d) Optionally, the offset is the gap between the last RB of the first PUSCH transmission and the first RB of the other PUSCH transmission in frequency domain.
3) Wherein, the frequency domain resource allocation of each PUSCH transmission is determined by the higher layer parameter in RRC signaling only.
   a. Further, the higher layer parameter is resourceAllocation in the case of DCI format 0_1 based scheduling and the higher layer parameter resourceAllocationDCI-0-2 in the case of DCI format 0_2 based scheduling.
   a. Further, the value of the higher layer parameter resourceAllocation or resource AllocationDCI-0-2 can be set as ‘resourceAllocation Type0’, ‘resourceAllocationType1’ or ‘dynamicSwitch’.
   b. Optionally, a plurality of the higher layer parameters are used for these PUSCH transmissions one by one.
      a) For example, if the number of these PUSCH transmissions is two, two higher layer parameters resourceAllocation or resourceAllocationDCI-0-2 configured to determine the for these two PUSCH transmissions.
   c. Optionally, only one higher layer parameter is configured to indicated the frequency domain resource allocations of all these PUSCH transmissions.
      a) Further, different parts of the indicated frequency domain resource allocations are used for different PUSCH transmissions, respectively. Where the number of the divided parts is equivalent to the number of these PUSCH transmissions.
         i. Optionally, the indicated frequency domain resource allocations are equally split to multiple parts for each PUSCH transmissions.
         i) For example, if the number of these PUSCH transmissions is 2, the first half of the indicated frequency domain resource allocations is used for the first PUSCH transmission, and the second half of the indicated frequency domain resource allocations is used for the second PUSCH transmission.
         ii. Optionally, even RBs and odd RBs within the allocated frequency domain resources are used for different PUSCH transmissions.
         i) For example, if the number of these PUSCH transmission is 2, the even RBs within the allocated frequency domain resources are used for the first PUSCH transmission, and the odd RBs within the allocated frequency domain resources are used for the first PUSCH transmission.
         iii. Optionally, even RBGs and odd RBGs within the allocated frequency domain resources are used for different PUSCH transmissions.)
         i) For example, if the number of these PUSCH transmission is 2, the even RBGs within the allocated frequency domain resources are used for the first PUSCH transmission, and the odd RBGs within the allocated frequency domain resources are used for the first PUSCH transmission.
         iv. Optionally, the indicated frequency domain resource allocations are split by a factor to determine the part of the indicated frequency domain resource allocations.
         i) Optionally, the factor associated to each PUSCH transmission can be the same or different.
         ii) Optionally, the factor depends on the MCS used for the PUSCH transmission.
         iii) Optionally, the factor depends on the transmission layer number of the PUSCH transmission.
         a. Optionally, the transmission layer number is determined by the higher layer parameter in RRC signaling.
         iv) Optionally, the factor depends on the UE capability reporting which associated with the PUSCH transmission.
         v) Optionally, the factor depends on the antenna port number of the PUSCH transmission.
         a. Optionally, the antenna port number is determined by the higher layer parameter in RRC signaling.
         vi) Optionally, the factor is configured by the higher layer parameter in RRC signaling of each PUSCH transmission.
   b. Optionally, only one higher layer parameter is configured to indicated the frequency domain resource allocation of one first PUSCH transmission, and then an offset of frequency domain resource allocations between the first PUSCH transmission and other PUSCH transmission is determined for the frequency domain resource allocation of the other PUSCH transmission.
      a) Optionally, the offset is configured by a higher layer parameter in RRC signaling.
      b) Optionally, the offset is the gap between the first RB of the first PUSCH transmission and the first RB of the other PUSCH transmission in frequency domain.
      c) Optionally, the offset is the gap between the last RB of the first PUSCH transmission and the first RB of the other PUSCH transmission in frequency domain.

In this patent document, some solutions to determine the transmission parameter determination for the case of multiple simultaneous PUSCH repetitions/transmissions transmitted from multi-panel and toward to multi-TRP. More precisely, it includes one or more of:
the configuration of SRS resource set, e.g.:
   the port number of SRS resource
   the number of SRS resources within one SRS resource set
   the composition of SRS resources within one SRS resource set when PUSCH scheduled by DCI format 0_2
   the associated NZP-CSI-RS of SRS resource set when non-codebook based PUSCH transmission
Frequency domain resource allocation when FDM based simultaneous PUSCH transmission in MTRP operation.
Uplink full power mode determination.
The indication of dynamic switching between STRP operation and MTRP operation.

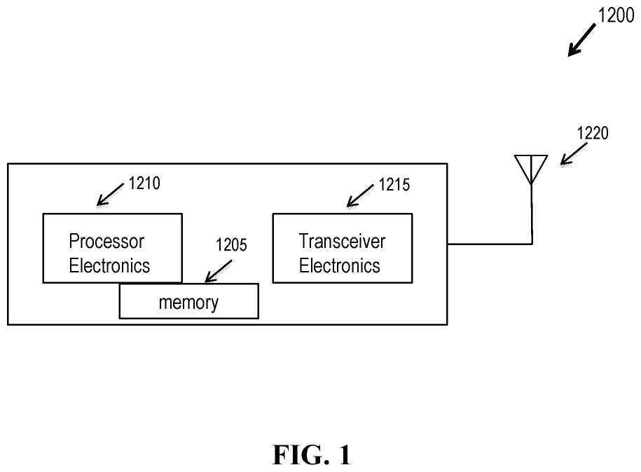

FIG. 1 is a block diagram of an example implementation of a wireless communication apparatus 1200. The methods described herein may be implemented by the apparatus 1200. In some embodiments, the apparatus 1200 may be a base station or a network device of a wireless network. In some embodiments, the apparatus 1200 may be a user device (e.g., a wireless device or a user equipment UE). The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

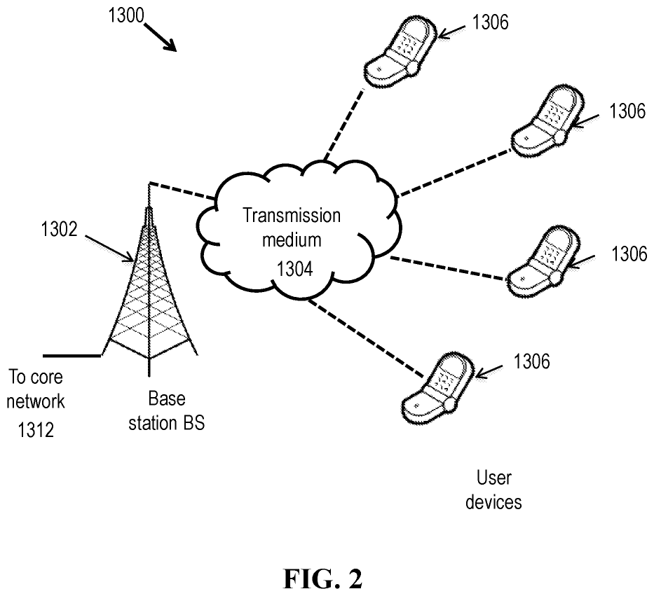

FIG. 2 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IOT) devices, and so on.

Some preferred embodiments may include the following solutions.

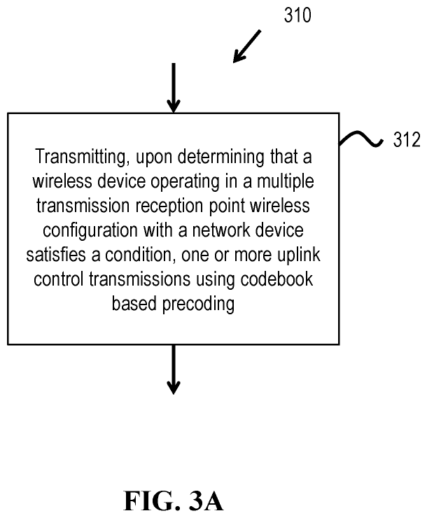

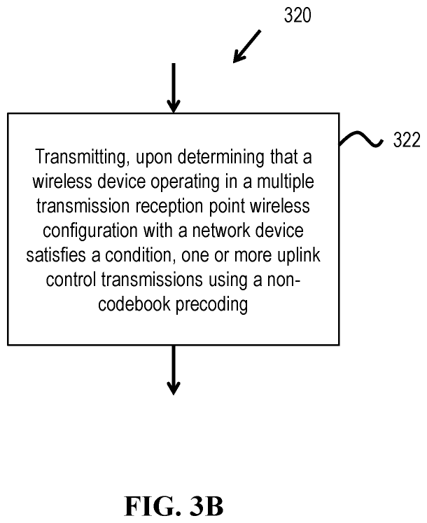

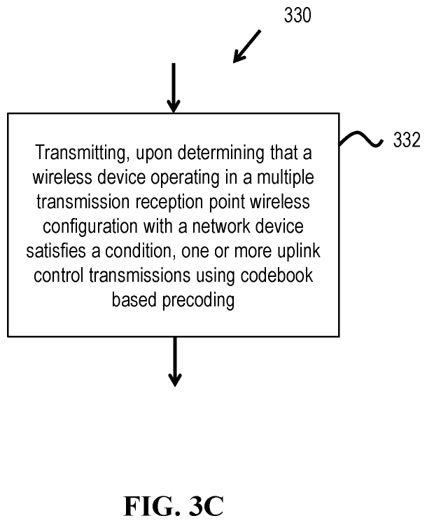

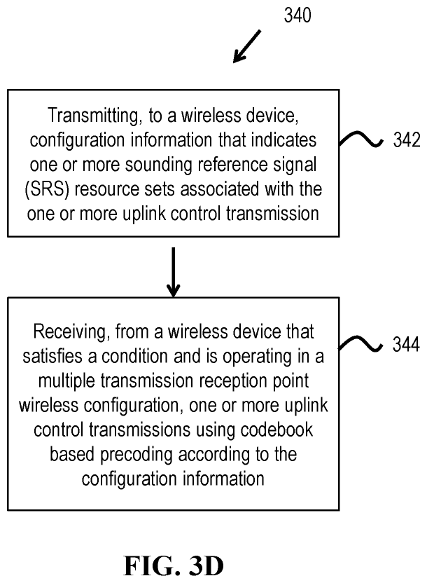

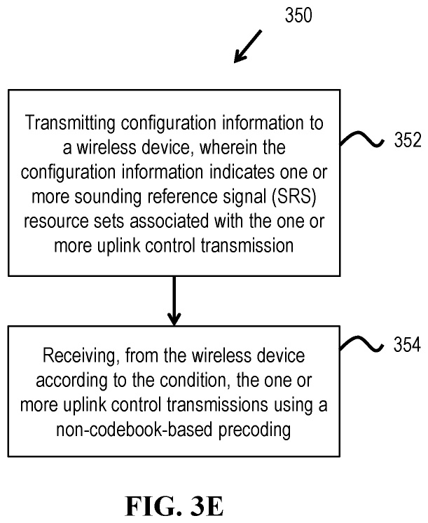

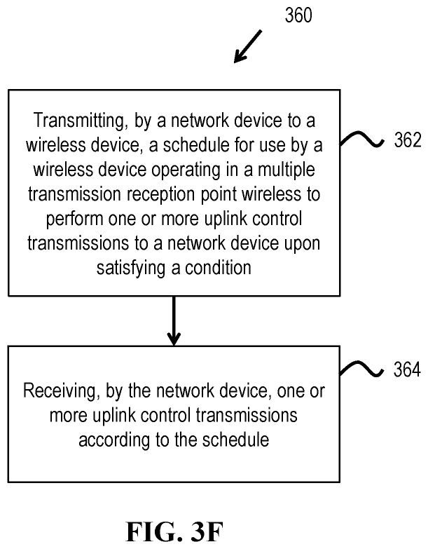

1. A method of wireless communication (e.g., method 310 as shown in FIG. 3A), comprising: transmitting 312, upon determining that a wireless device operating in a multiple transmission reception point wireless configuration with a network device satisfies a condition, one or more uplink control transmissions using codebook based precoding, wherein the one or more uplink control transmissions are performed according to a configuration information received from a network device that indicates one or more sounding reference signal (SRS) resource sets associated with the one or more uplink control transmission.

2. The method of solution 1, wherein the condition comprises that the wireless device is scheduled to transmit more than one uplink control transmissions and the more than one uplink control transmissions are partly or entirely overlapping in a time domain.

3. The method of any of solutions 1-2, wherein the condition comprises that the one or more uplink control transmissions are respectively associated with the one or more SRS resource sets to use a codebook based precoding.

4. The method of any of solutions 1-2, wherein the one or more uplink control transmissions are transmitted simultaneously using a same SRS resource set.

5. The method of any of solutions 1-4, wherein at least one of the one or more uplink control transmissions comprises at least one of: a physical uplink shared channel (PUSCH) transmission, a PUSCH transmission occasion, or a PUSCH repetition.

6. The method of solution 5, wherein the configuration information is received by a radio resource control layer signaling that comprises one or more parameters.

7. The method of solution 6, wherein one parameter indicates a number of SRS resources in the SRS resource set.

8. The method of any of solutions 6-7, wherein a maximum number of SRS resources in the SRS resource set depends on a capability reported by the wireless device.

9. The method of any of solutions 6-8, wherein one parameter indicates a number antenna ports configured for a uplink control transmission.

10. The method of solution 9, wherein a same number of antenna ports are configured for each SRS resource in the SRS resource set.

11. The method of solution 9, wherein different number of antenna ports are configured for SRS resources in the SRS resource set.

12. The method of any of solutions 6-11, wherein a maximum number of transmission layers for the one or more uplink control transmissions is less than or equal to a smallest of a maximum number of antenna ports of indicated SRS resources in the SRS resource set.

Embodiments 1 and 2 provide further example features of the above-recited solutions.

13. A method of wireless communication (e.g., method 320 as shown in FIG. 3B), comprising: transmitting 322, upon determining that a wireless device operating in a multiple transmission reception point wireless configuration with a network device satisfies a condition, one or more uplink control transmissions using a non-codebook-based precoding, wherein the one or more uplink control transmissions are performed according to a configuration information received from a network device that indicates one or more sounding reference signal (SRS) resource sets associated with the one or more uplink control transmission.

14. The method of solution 13, wherein the condition comprises that the wireless device is scheduled to transmit more than one uplink control transmissions and the more than one uplink control transmissions partly or entirely overlap in a time domain.

15. The method of any of solutions 13-14, wherein the condition comprises that the one or more uplink control transmissions are respectively associated with the one or more SRS resource sets to use a non-codebook based precoding.

16. The method of any of solutions 13-14, wherein the one or more uplink control transmissions are transmitted simultaneously using a same SRS resource set.

17. The method of any of solutions 13-16, wherein at least one of the one or more uplink control transmissions comprises at least one of a physical uplink shared channel (PUSCH) transmission, a PUSCH transmission occasion, or a PUSCH repetition.

18. The method of solution 17, wherein the configuration information is received by a radio resource control layer signaling that comprises one or more parameters.

19. The method of solution 18, wherein one parameter indicates a number of SRS resources in the SRS resource set.

20. The method of any of solution 18-19, wherein a maximum number of SRS resources in the SRS resource set depends on a capability reported by the wireless device.

21. The method of any of solutions 18-20, wherein one parameter indicates one or more non-zero power (NZP) channel state information reference signal (CSI-RS) resource respectively associated with the one or more SRS resource sets.

22. The method of any of solutions 18-21, wherein a maximum number of transmission layers for the one or more uplink control transmissions is less than or equal to a smallest of a maximum number of antenna ports of indicated SRS resources in the SRS resource set.

Embodiments 3 and 4 provide further example features of the above-recited solutions.

23. A method of wireless communication (e.g., method 330 as shown in FIG. 3C), comprising: transmitting 332, upon determining that a wireless device operating in a multiple transmission reception point wireless configuration with a network device satisfies a condition, one or more uplink control transmissions, wherein the one or more uplink control transmissions are performed according to a frequency domain resource allocation provided by the network device.

24. The method of solution 23, wherein the condition comprises that the wireless device is scheduled to transmit more than one uplink control transmissions and the more than one uplink control transmissions partly or entirely overlap in a time domain.

25. The method of any of solution 23-24, wherein the condition comprises that the one or more uplink control transmissions are transmitted in non-consecutive resources in the frequency domain.

26. The method of any of solutions 23-25, wherein the condition comprises that the one or more uplink control transmissions are indicated using a same or different redundancy versions.

27. The method of any of solutions 23-25, wherein the condition comprises that the one or more uplink control transmissions are indicated using different redundancy versions.

28. The method of any of solutions 23-27, wherein condition comprises that the one or more uplink control transmissions are respectively associated with one or more SRS resource sets indicated as codebook or non-codebook-based transmissions.

29. The method of any of solutions 23-28, wherein the condition comprises that the one or more uplink control transmissions are indicated with different beams or with different spatial relations.

30. The method of any of solutions 23-29, wherein the condition comprises that the one or more uplink control transmissions are scheduled for transmission in frequency range 1 or frequency range 2.

31. The method of any of solutions 23-30, wherein the one or more uplink control transmissions comprise at least one of: one or more physical uplink shared channel (PUSCH) transmission occasions, one or more PUSCH repetitions, one or more PUSCH non-repetitions, one or more inter-slot based PUSCH transmission occasions, or one or more intra-slot based PUSCH transmission occasions.

32. The method of any of solutions 23-31, wherein the performing the one or more uplink control transmissions according to the frequency domain resource allocation provided by the network device comprises assigning frequency domain resources to the one or more uplink control transmissions according to a rule.

33. The method of solution 32, wherein the rule specifies that, in case that the one or more uplink control transmissions use a cyclic prefix orthogonal frequency division multiplexing (CP-OFDM) waveform and in case that an uplink resource allocation scheme type 0 is configured for the wireless device, one or more of following is used:
in case that frequency range 1 is used, using contiguous or non-contiguous frequency domain resources within component carriers for the one or more uplink control transmissions in case that the frequency domain resources are allocated with an almost-contiguous-allocation, otherwise using only contiguous frequency domain resources, or
in case that frequency range 2 is used, using contiguous frequency domain resources for each and all of the one or more uplink channel transmissions.

34. The method of solution 32, wherein the rule specifies that, in case that the one or more uplink control transmissions use a cyclic prefix orthogonal frequency division multiplexing (CP-OFDM) waveform and in case that an uplink resource allocation scheme type 1 or 2 is configured for the wireless device, then for both frequency range 1 and frequency range 2, contiguous frequency domain resources are used for each and all of the one or more uplink channel transmissions.

35. The method of solution 32, wherein the rule specifies that, in case that the one or more uplink control transmissions use a discrete Fourier transform orthogonal frequency division multiplexing (DFT-s-OFDM) waveform and in case that an uplink resource allocation scheme type 1 or 2 is configured for the wireless device, then for both frequency range 1 and frequency range 2, contiguous frequency domain resources are used for each and all of the one or more uplink channel transmissions.

36. The method of solution 32, wherein frequency domain allocations of the one or more uplink control transmissions are indicated by at least one indication field in a downlink control information (DCI) message having a format 0_1 or format 0_2.

37. The method of any of solutions 23-36, wherein the frequency domain allocation is provided in a radio resource control (RRC) message that includes one or more parameters.

38. The method of solution 37, wherein the RRC message indicates a higher layer parameter resourceAllocation in case of DCI format 0_1 based scheduling and resourceAllocationDCI-0-2 in case of DCI format 0_2 based scheduling.

Embodiment 5 provide further example features of the above-recited solutions.

39. A method of wireless communication (e.g., method 340 as shown in FIG. 3D), comprising: transmitting 342, by a network device to a wireless device, configuration information that indicates one or more sounding reference signal (SRS) resource sets associated with the one or more uplink control transmission; and receiving 344, from a wireless device that satisfies a condition and is operating in a multiple transmission reception point wireless configuration, one or more uplink control transmissions using codebook based precoding according to the configuration information.

The above solution may further include features as recited in above-listed solutions 2-12.

40. A method of wireless communication (e.g., method 350 as shown in FIG. 3E), comprising: transmitting 352, by a network node, configuration information to a wireless device, wherein the configuration information indicates one or more sounding reference signal (SRS) resource sets associated with the one or more uplink control transmission; and receiving 354, from the wireless device according to the condition, the one or more uplink control transmissions using a non-codebook-based precoding.

The above solution may further include features as recited in above-listed solutions 14-22.

41. A method of wireless communication (e.g., method 360 as shown in FIG. 3F), comprising: transmitting 362, by a network device to a wireless device, a schedule for use by a wireless device operating in a multiple transmission reception point wireless to perform one or more uplink control transmissions to a network device upon satisfying a condition; and receiving 364, by the network device, one or more uplink control transmissions according to the schedule.

The above solution may further include features as recited in above-listed solutions 26-40.

42. A wireless communication apparatus comprising a processor configured to implement a method recited in any of solutions 1-41.

43. A computer storage medium having code stored thereupon, the code, upon execution by a processor, causing the processor to implement a method recited in any of solutions 1-41.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, upon determining that a wireless device operating in a multiple transmission reception point wireless configuration with a network device satisfies a condition, one or more uplink control transmissions using a codebook-based or non-codebook-based precoding,
wherein the one or more uplink control transmissions are performed according to a configuration information received from a network device that indicates one or more sounding reference signal (SRS) resource sets associated with the one or more uplink control transmission,
wherein at least one of the one or more uplink control transmissions comprises at least one of: a physical uplink shared channel (PUSCH) transmission, a PUSCH transmission occasion, or a PUSCH repetition,
wherein the configuration information is received by a radio resource control layer signaling that comprises one or more parameters.

2. The method of claim 1, wherein the condition is satisfied in a case that the wireless device is scheduled to transmit more than one uplink control transmissions and the more than one uplink control transmissions are partly or entirely overlapping in a time domain.

3. The method of claim 1, wherein the codebook-based or non-codebook-based precoding is a codebook based precoding, wherein the condition is satisfied in a case that the one or more uplink control transmissions are respectively associated with the one or more SRS resource sets to use a codebook based precoding.

4. The method of claim 1, wherein the one or more uplink control transmissions are transmitted simultaneously using a same SRS resource set.

5-6. (canceled)

7. The method of claim 1, wherein one of the one or more parameters indicates a number of SRS resources in the SRS resource set.

8. The method of claim 1, wherein a maximum number of SRS resources in the SRS resource set depends on a capability reported by the wireless device.

9. The method of claim 1, wherein the codebook-based or non-codebook-based precoding is a codebook based precoding, wherein one of the one or more parameters indicates a number of antenna ports configured for an uplink control transmission.

10. The method of claim 9, wherein a same number of antenna ports are configured for each SRS resource in the SRS resource set.

11. The method of claim 9, wherein different number of antenna ports are configured for SRS resources in the SRS resource set.

12. The method of claim 1, wherein a maximum number of transmission layers for the one or more uplink control transmissions is less than or equal to a smallest value of a maximum number of antenna ports of indicated SRS resources in the SRS resource set.

13-14. (canceled)

15. The method of claim 1, wherein the codebook-based or non-codebook-based precoding is a non-codebook based precoding, wherein the condition is satisfied in a case that the one or more uplink control transmissions are respectively associated with the one or more SRS resource sets to use the non-codebook based precoding.

16-20. (canceled)

21. The method of claim 1, wherein the codebook-based or non-codebook-based precoding is a non-codebook based precoding, wherein one of the one or more parameters indicates one or more non-zero power (NZP) channel state information reference signal (CSI-RS) resources respectively associated with the one or more SRS resource sets.

22. The method of claim 1, wherein the codebook-based or non-codebook-based precoding is a non-codebook based precoding, wherein a maximum number of transmission layers for the one or more uplink control transmissions is less than or equal to a smallest value of a maximum number of antenna ports of indicated SRS resources in the SRS resource set.

23. A method of wireless communication, comprising:
transmitting, upon determining that a wireless device operating in a multiple transmission reception point wireless configuration with a network device satisfies a condition, one or more uplink control transmissions,
wherein the one or more uplink control transmissions are performed according to a frequency domain resource allocation provided by the network device,
wherein the condition is satisfied in a case that the one or more uplink control transmissions are transmitted in non-consecutive resources in a frequency domain corresponding to the frequency domain resource allocation.

24. The method of claim 23, wherein the condition is satisfied in a case that the wireless device is scheduled to transmit more than one uplink control transmissions and the more than one uplink control transmissions partly or entirely overlap in a time domain.

25. (canceled)

26. The method of claim 23, wherein the condition is satisfied in a case that: the one or more uplink control transmissions are indicated using a same or different redundancy versions; or the one or more uplink control transmissions are indicated using different redundancy versions.

27. (canceled)

28. The method of claim 23, wherein the condition is satisfied in a case that: the one or more uplink control transmissions are respectively associated with one or more SRS resource sets indicated as codebook or non-codebook-based transmissions; or the one or more uplink control transmissions are indicated with different beams or with different spatial relations.

29-30. (canceled)

31. The method of claim 23, wherein the one or more uplink control transmissions comprise at least one of: one or more physical uplink shared channel (PUSCH) transmission occasions, one or more PUSCH repetitions, one or more PUSCH non-repetitions, one or more inter-slot based PUSCH transmission occasions, or one or more intra-slot based PUSCH transmission occasions.

32. The method of claim 23, wherein the performing the one or more uplink control transmissions according to the frequency domain resource allocation provided by the network device comprises assigning frequency domain resources to the one or more uplink control transmissions according to a rule.

33-36. (canceled)

37. The method of claim 23, wherein the frequency domain allocation is provided in a radio resource control (RRC) message that includes one or more parameters.

38-43. (canceled)
